(19) United States
(12) Patent Application Publication
(10) Pub. No.: US 2025/0384224 A1
(43) Pub. Date: Dec. 18, 2025

(54) APPARATUS AND METHOD OF PROCESSING NATURAL LANGUAGE USING BOOSTING KEYWORD SET AND SUPPRESSING KEYWORD SET

(71) Applicant: Sionic AI Inc., Seoul (KR)

(72) Inventors: Woomyoung Park, Seoul (KR); Sukhyun Ko, Seoul (KR)

(21) Appl. No.: 19/175,512

(22) Filed: Apr. 10, 2025

(30) Foreign Application Priority Data
Jun. 12, 2024 (KR) 10-2024-0076331

(51) Int. Cl. G06F 40/56

(52) U.S. Cl. CPC G06F 40/56

(57) ABSTRACT

A natural language processing method performed in an electronic device including at least one processor and at least one memory storing commands to be executed by the at least one processor, the method including acquiring a boosting keyword set including at least one boosting keyword that is an object of generation boost when generating a sentence using an artificial neural network model, acquiring a suppressing keyword set including at least one suppressing keyword that is an object of generation suppression when generating a sentence using the artificial neural network model, and generating sentences through the artificial neural network model based on the boosting keyword set and the suppressing keyword set.

### CROSS-REFERENCE TO RELATED APPLICATION

This application claims priority under 35 U.S.C § 119 to Korean Patent Application No. 10-2024-0076331, filed in the Korean Intellectual Property Office on Jun. 12, 2024, the entire contents of which are hereby incorporated by reference.

### BACKGROUND

### 1. Field

The present disclosure relates to technologies for processing natural language by using keyword sets.

### 2. Description of the Related Art

Recently, in the field of natural language processing technologies, there is a trend of using an LLM (Large Language Model) as a base model, while performing post-processing techniques such as fine-tuning or few-shot learning according to a user's purpose.

However, according to at least some implementations, if the base LLM model is a model trained in a foreign language, then a foreign language appears in fields requiring Korean language generation. Also, due to the user's inability to modify a training data set of the base LLM model, unnecessary or undesired keywords may be generated.

Accordingly, while using an existing LLM model as a base model, there is an increased demand for a technology that may control sentences generated in an inference process according to types of keywords that a user wants.

Korean Patent Registration No. 10-2668859 discloses “Natural Language Processing-Based Control System, Its Operating Method, and Its Communication Method.”

### SUMMARY

The present disclosure provides a technology for processing natural language by using a boosting keyword set and a suppressing keyword set.

The present disclosure may be implemented in various ways, including methods, devices (systems), or non-transitory computer-readable recording media storing instructions.

As one aspect of the present disclosure, a natural language processing method performed in an electronic device including at least one processor and at least one memory storing commands to be executed by the at least one processor, may include acquiring a boosting keyword set including at least one boosting keyword that is an object of generation boost when generating a sentence using an artificial neural network model, acquiring a suppressing keyword set including at least one suppressing keyword that is an object of generation suppression when generating a sentence using the artificial neural network model, and generating sentences through the artificial neural network model based on the boosting keyword set and the suppressing keyword set.

In some implementations, the boosting keyword set may be a keyword set related to a first language, and the suppressing keyword set may be a keyword set related to a second language.

In some implementations, the boosting keyword set or the suppressing keyword set may be generated based on a word distribution in public data related to a target language and a word distribution in proprietary data input by a user.

In some implementations, the boosting keyword set may include words that appear at a frequency lower than a first threshold frequency in the public data and appear at a frequency higher than a second threshold frequency in the proprietary data.

In some implementations, the suppressing keyword set may include words that appear at a frequency higher than a third threshold frequency in the public data and appear at a frequency lower than a fourth threshold frequency in the proprietary data.

In some implementations, generating the sentences through the artificial neural network model may include calculating a generation probability for each of a plurality of tokens based on an output of the artificial neural network model for an input token sequence, and determining a subsequent token.

In some implementations, the generation probability for each of the plurality of tokens may be calculated differently according to a classification of each token.

In some implementations, the generation probability for each of the plurality of tokens may be calculated by using a first probability distribution control parameter for increasing the generation probability if a token is included in a set of tokens of the boosting keyword set, and by using a second probability distribution control parameter for decreasing the generation probability if the token is included in a set of tokens of the suppressing keyword set.

In some implementations, generating the sentences through the artificial neural network model may be performed by using a keyword trie including at least one node. The at least one node may include a token and a keyword state value for a token sequence including tokens of each node on a path from a root node to a current node.

In some implementations, the keyword trie may be generated based on the boosting keyword set or the suppressing keyword set.

In some implementations, generating the sentences through the artificial neural network model may include generating a first token sequence by using a first probability distribution control parameter, generating a second token sequence by using the first probability distribution control parameter and a second probability distribution control parameter, and replacing one of the first token sequence and the second token sequence with the other of the first token sequence and the second token sequence if a predetermined condition is satisfied. The predetermined condition may be a condition of which satisfaction is determined based on the keyword trie.

In some implementations, replacing the one of the first token sequence and the second token sequence with the other of the first token sequence and the second token sequence may include if the first token sequence is determined to include the suppressing keyword, replacing the first token sequence with the second token sequence, and if the first token sequence is determined to include the boosting keyword or is determined not to include the suppressing keyword, replacing the second token sequence with the first token sequence.

In some implementations, generating the sentences through the artificial neural network model may include generating a first token sequence by using a first probability distribution control parameter, and if the first token sequence is determined to include the suppressing keyword, generating a second token sequence by using the first probability distribution control parameter and a second probability distribution control parameter.

In some implementations, generating the sentences through the artificial neural network model may include generating a plurality of candidate token sequences by determining a plurality of subsequent tokens using the artificial neural network model for each of N token sequences where N is a natural number of at least 2, calculating, according to a predetermined calculation method, an accumulated probability for each of the plurality of candidate token sequences, and determining N token sequences among the plurality of candidate token sequences based on the accumulated probability.

In some implementations, calculating, according to the predetermined calculation method, the accumulated probability for each of the plurality of candidate token sequences may include if a candidate token sequence is determined to include the boosting keyword, increasing the accumulated probability, and if the candidate token sequence is determined to include the suppressing keyword, decreasing the accumulated probability.

As another aspect of the present disclosure, an electronic device may include at least one processor, and at least one memory storing commands to be executed by the at least one processor. The at least one processor may be configured to acquire a boosting keyword set including at least one boosting keyword that is an object of generation boost when generating a sentence using an artificial neural network model, acquire a suppressing keyword set including at least one suppressing keyword that is an object of generation suppression when generating a sentence using the artificial neural network model, and generate sentences through the artificial neural network model based on the boosting keyword set and the suppressing keyword set.

As another aspect of the present disclosure, a non-transitory computer-readable recording medium may store commands causing at least one processor to perform operations. The commands may cause the at least one processor to acquire a boosting keyword set including at least one boosting keyword that is an object of generation boost when generating a sentence using an artificial neural network model, acquire a suppressing keyword set including at least one suppressing keyword that is an object of generation suppression when generating a sentence using the artificial neural network model, and generate sentences through the artificial neural network model based on the boosting keyword set and the suppressing keyword set.

A natural language processing method according to the present disclosure may improve natural language processing speed.

A natural language processing method according to the present disclosure may generate sentences by controlling generation probabilities according to types of keywords.

A natural language processing method according to the present disclosure may increase a probability that generated sentences include boosting keywords.

A natural language processing method according to the present disclosure may decrease a probability that generated sentences include suppressing keywords.

Effects of the present disclosure are not limited to the effects mentioned above, and various other effects not mentioned will be clearly understood by those of ordinary skill in the art (one of ordinary skill) to which the present disclosure pertains from the description of the claims.

### BRIEF DESCRIPTION OF THE DRAWINGS

Embodiment(s) of the present disclosure will be described below with reference to the accompanying drawings, in which like reference numerals refer to like elements, without being limited thereto.

FIG. 1 is a diagram illustrating a system including a server, a user terminal, and a communication network.

FIG. 2 is a block diagram of a server.

FIG. 3 is a block diagram of a user terminal.

FIG. 4 is a flowchart illustrating a natural language processing method.

FIG. 5 is a conceptual diagram illustrating a keyword trie.

FIG. 6 is a flowchart illustrating a first example of generating a sentence by using a keyword trie.

FIG. 7 is a flowchart illustrating a second example of generating a sentence by using a keyword trie.

FIG. 8 is a flowchart illustrating a third example of generating a sentence by using a keyword trie.

### DETAILED DESCRIPTION

Various embodiment(s) described in the present document are presented for the purpose of clearly explaining the technical spirit of the present disclosure, and these are merely examples and are not intended to limit the present disclosure to specific implementation forms. The technical spirit of the present disclosure includes various modifications, equivalents, alternatives, and embodiment(s) selectively combined from all or a part of each embodiment described in the present document. Also, a scope of rights of the technical spirit of the present disclosure is not limited by the various embodiment(s) described below or by specific descriptions thereof.

Unless defined otherwise, terms used in the present document, including technical or scientific terms, may have meanings generally understood by those skilled in the art to which the present disclosure pertains.

Expressions such as “include,” “may include,” “have,” and “may have,” used in the present document, mean that a feature (for example, function, operation, or component) exists, and do not exclude the existence of other additional features. In other words, such expressions should be understood as open-ended terms that imply that other embodiment(s) may be included.

Singular expressions used in the present document may include plural meanings unless the context clearly indicates otherwise, and the same applies to singular expressions recited in the claims.

Expressions such as “first,” “second,” or “primary,” “secondary,” etc., used in the present document, are used to distinguish one subject from another among a plurality of identical subjects, unless the context clearly indicates otherwise, and do not limit order or importance among the subjects. For example, a plurality of keywords according to the present disclosure may each be distinguished from one another by being referred to as “first keyword,” “second keyword,” and so forth. Likewise, terms such as “threshold frequency” or “probability distribution control parameter,” used in the present disclosure, may be distinguished from one another by being referred to as “first,” “second,” etc.

Expressions such as “A, B, and C,” “A, B, or C,” “at least one of A, B, and C,” or “at least one of A, B, or C,” used in the present document, may indicate all possible combinations of each enumerated item or enumerated items. For example, “at least one of A or B” may refer to (1) at least one A, (2) at least one B, or (3) at least one A and at least one B.

The term “unit,” used in the present document, may refer to a software component or a hardware component such as an FPGA (Field-Programmable Gate Array) or an ASIC (Application Specific Integrated Circuit). However, “unit” is not limited to hardware and software. “Unit” may be configured to be stored in an addressable storage medium or configured to execute one or more processors. In some implementations, “unit” may include software components, object-oriented software components, class components, and task components, as well as processor, function, attribute, procedure, subroutine, program code segments, driver, firmware, microcode, circuits, data, database, data structure, table, array, and variables.

The expression “based on” used in the present document is used to describe one or more factors that affect an act of determining or judging in an expression or sentence in which the expression appears, and the expression does not exclude additional factors that affect such act of determining or judging.

The expression that a certain component (for example, a first component) is “connected” or “coupled” to another component (for example, a second component) used in the present document may mean that the certain component is directly connected or coupled to the other component, as well as that the certain component is connected or coupled through a newly introduced component (for example, a third component).

The expression “configured to” used in the present document may mean “set to,” “having the ability to,” “modified to,” “manufactured to,” or “capable of,” depending on the context. This expression is not limited to the meaning “specifically designed in hardware,” and, for example, a processor configured to perform a certain operation may be understood as a general-purpose processor capable of performing that certain operation by executing software, or a special-purpose computer structured through programming to perform that certain operation.

In the present disclosure, “artificial intelligence (AI)” refers to a technology that imitates human learning ability, reasoning ability, and perception ability, and implements them on a computer, and may include concepts of machine learning and symbolic logic. Machine learning (ML) may be an algorithmic technology that independently classifies or learns features of input data. AI technologies analyze input data with a machine learning algorithm, learn from the analysis results, and may perform judgment or prediction based on the learning results. Furthermore, technologies that imitate the cognitive and judgment functions of a human brain by utilizing machine learning algorithms are also understood to fall within the scope of AI. For example, there may be fields of linguistic understanding, visual understanding, inference/prediction, knowledge representation, and operation control.

In the present disclosure, machine learning may refer to a process of training a neural network model by using experience with data. Machine learning may mean that computer software independently improves data processing capability. A neural network model is built by modeling correlations among data, and those correlations may be expressed by a plurality of parameters. An artificial neural network model extracts and analyzes features from given data to derive correlations among data, and machine learning is a process of repeating these steps to optimize parameters of the neural network model. For example, the artificial neural network model may learn a mapping (correlation) between inputs and outputs for data given as input-output pairs. Alternatively, the artificial neural network model may learn correlations among given data by deriving regularities among the given data even when only input data are provided.

In the present disclosure, an artificial neural network, an artificial intelligence learning model, a machine learning model, or an artificial neural network model may be designed to implement the structure of the human brain on a computer and may include a plurality of network nodes that simulate neurons of the human neural network and have weights. The plurality of network nodes may have interconnections that simulate synaptic activity of neurons, in which neurons exchange signals with each other through synapses. In an artificial neural network, the plurality of network nodes may transmit and receive data according to convolution connections while being located in layers of different depths. Examples of the artificial neural network may include, for instance, an artificial neural network model or a convolutional neural network model.

Various embodiment(s) of the present disclosure are described below with reference to the attached drawings. In the attached drawings and the description thereof, the same or substantially equivalent components may be assigned the same reference numerals. Further, in the following descriptions of various embodiment(s), repeated descriptions of the same or corresponding components may be omitted, but this does not mean that such components are not included in those embodiment(s).

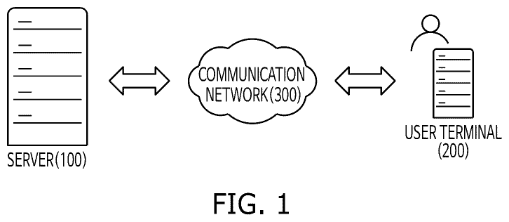

FIG. 1 is a diagram illustrating a system including a server 100, a user terminal 200, and a communication network 300. The server 100 and the user terminal 200 may transmit or receive information to or from each other through the communication network 300.

The server 100 may be an electronic device performing a natural language processing operation according to the present disclosure. The server 100 may be, for example, an application server, a proxy server, or a cloud server that transmits information or transmits a natural language processing result to a user terminal 200 connected via wired or wireless communication.

The user terminal 200 may be a terminal of a user who intends to receive the natural language processing result. The user terminal 200 may be, for example, at least one of a smartphone, a tablet computer, a PC (Personal Computer), a mobile phone, a PDA (Personal Digital Assistant), an audio player, or a wearable device. The communication network 300 may include both wired or wireless communication networks.

The communication network 300 may allow data to be exchanged between the server 100 and the user terminal 200. Examples of wired communication networks may include communication networks according to methods such as USB (Universal Serial Bus), HDMI (High Definition Multimedia Interface), RS-232 (Recommended Standard-232), or POTS (Plain Old Telephone Service). Examples of wireless communication networks may include communication networks according to methods such as eMBB (enhanced Mobile Broadband), URLLC (Ultra Reliable Low-Latency Communications), MMTC (Massive Machine Type Communications), LTE (Long-Term Evolution), LTE-A (LTE Advance), NR (New Radio), UMTS (Universal Mobile Telecommunications System), GSM (Global System for Mobile Communications), CDMA (Code Division Multiple Access), WCDMA (Wideband CDMA), WiBro (Wireless Broadband), WiFi (Wireless Fidelity), Bluetooth, NFC (Near Field Communication), GPS (Global Positioning System), or GNSS (Global Navigation Satellite System). The communication network 300 of the present specification is not limited to the above examples and may include, without limitation, various types of communication networks that allow data to be exchanged among multiple entities or devices.

In the disclosure of the present specification, when describing a configuration or an operation of a device, the term “device” is used to refer to the device being described, and the term “external device” is used to refer to a device that exists outside of the device being described from the perspective of that device. For example, when the server 100 is set as the “device” in a description, from the perspective of the server 100, the user terminal 200 may be referred to as an “external device.” Also, for example, when the user terminal 200 is set as the “device” in a description, from the perspective of the user terminal 200, the server 100 may be referred to as an “external device.” In other words, each of the server 100 and the user terminal 200 may each be referred to as “device” and “external device,” or “external device” and “device,” depending on the viewpoint of the operating entity.

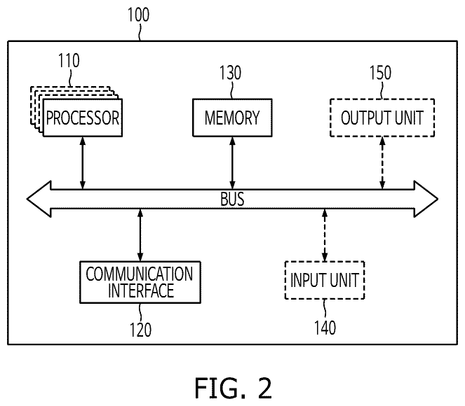

FIG. 2 is a block diagram of the server 100. The server 100 may include, as components, at least one processor 110, a communication interface 120, and a memory 130. In some implementations, at least one of these components of the server 100 may be omitted, or other components may be added to the server 100. In some implementations, additionally or alternatively, some of the components may be integrated, or implemented as a single or multiple entities. At least some of the components, whether inside or outside the server 100, may be connected to each other through a bus, GPIO (General Purpose Input/Output), SPI (Serial Peripheral Interface), or MIPI (Mobile Industry Processor Interface), to transmit or receive data or signals.

The at least one processor 110 may be referred to as the processor 110. The term “processor 110” may mean a set of one or more processors unless clearly expressed otherwise in context. The processor 110 may execute software (for example, commands, programs, etc.) to control at least one component of the server 100 connected to the processor 110. Also, the processor 110 may perform various operations such as computation, processing, data generation, or data modification. The processor 110 may also load data from or store data in the memory 130.

The communication interface 120 may perform wireless or wired communication between the server 100 and another device (for example, the user terminal 200 or another server). For example, the communication interface 120 may perform wireless communication according to methods such as eMBB, URLLC, MMTC, LTE, LTE-A, NR, UMTS, GSM, CDMA, WCDMA, WiBro, WiFi, Bluetooth, NFC, GPS, or GNSS. Also, for example, the communication interface 120 may perform wired communication according to methods such as USB (Universal Serial Bus), HDMI (High Definition Multimedia Interface), RS-232 (Recommended Standard-232), or POTS (Plain Old Telephone Service).

The memory 130 may store various data. The data stored in the memory 130 may include software (for example, commands, programs, etc.) acquired, processed, or used by at least one component of the server 100. The memory 130 may include volatile or non-volatile memory. The term “memory 130” may mean a set of one or more memories unless clearly expressed otherwise in context. The expression “a set of commands (Instructions) stored in the memory 130” or “a program stored in the memory 130” in the present specification may be used to refer to an operating system, an application, or middleware that provides various functionalities to the application so that the application can utilize resources of the server 100. In some implementations, when the processor 110 performs a certain operation, the memory 130 may store commands corresponding to the certain operation performed by the processor 110.

In some implementations, the server 100 may transmit data according to an operation result of the processor 110, data received by the communication interface 120, or data stored in the memory 130, to an external device. The external device may be a device for presenting, displaying, or outputting the received data.

In some implementations, the server 100 may further include an input unit 140. The input unit 140 may be a component that delivers data received from outside to at least one component included in the server 100. For example, the input unit 140 may include at least one of a mouse, a keyboard, or a touch pad.

In some implementations, the server 100 may further include an output unit 150. The output unit 150 may display (output) information processed by the server 100 or may transmit (send) the information to the outside. For example, the output unit 150 may visually display information processed by the server 100. The output unit 150 may display UI (User Interface) information or GUI (Graphic User Interface) information, among others. In such a case, the output unit 150 may include at least one of an LCD (Liquid Crystal Display), a TFT-LCD (Thin Film Transistor-Liquid Crystal Display), an OLED (Organic Light-Emitting Diode), a Flexible Display, a 3D Display, or an E-ink Display. Also, for example, the output unit 150 may audibly present information processed by the server 100. The output unit 150 may present audio data, following an arbitrary audio file format (for example, MP3, FLAC, WAV, etc.), through an audio device. In such a case, the output unit 150 may include at least one of a speaker, a headset, or a headphone. Also, for example, the output unit 150 may transmit information processed by the server 100 to an external output device. The output unit 150 may transmit or send information processed by the server 100 to the external output device by using the communication interface 120. The output unit 150 may also transmit or send information processed by the server 100 to an external output device by using a separate output communication interface.

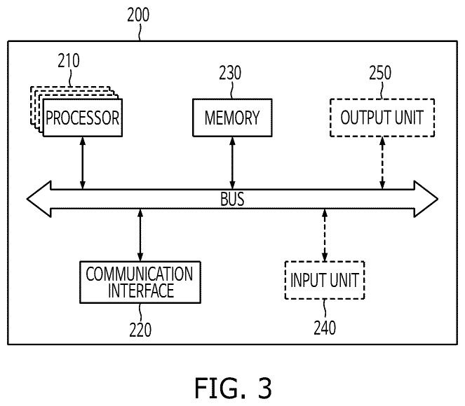

FIG. 3 is a block diagram of the user terminal 200. The user terminal 200 may include, as components, at least one processor 210, a communication interface 220, and a memory 230. Also, the user terminal 200 may further include at least one of an input unit 240 or an output unit 250.

The processor 210 may execute software (for example, commands, programs, etc.) to control at least one component of the user terminal 200 connected to the processor 110. The processor 210 may also perform various operations such as computation, processing, data generation, or data modification. The processor 210 may also load data from or store data in the memory 230.

The communication interface 220 may perform wireless or wired communication between the user terminal 200 and another device (for example, the server 100 or another user terminal). For example, the communication interface 220 may perform wireless communication according to methods such as eMBB, URLLC, MMTC, LTE, LTE-A, NR, UMTS, GSM, CDMA, WCDMA, WiBro, WiFi, Bluetooth, NFC, GPS, or GNSS. Also, for example, the communication interface 220 may perform wired communication according to methods such as USB, HDMI, RS-232, or POTS.

The memory 230 may store various data. The data stored in the memory 230 may include software (for example, commands, programs, etc.) acquired, processed, or used by at least one component of the user terminal 200. The memory 230 may include volatile or non-volatile memory. The term “memory 230” may mean a set of one or more memories unless clearly expressed otherwise in context. The expression “a set of commands (Instructions) stored in the memory 230” or “a program stored in the memory 230” in the present specification may be used to refer to an operating system, an application, or middleware that provides various functionalities to the application so that the application can utilize resources of the user terminal 200. In some implementations, when the processor 210 performs a certain operation, the memory 230 may store commands corresponding to the certain operation performed by the processor 210.

In some implementations, the user terminal 200 may further include the input unit 240. The input unit 240 may be a component that delivers data received from outside to at least one component included in the user terminal 200. For example, the input unit 240 may include at least one of a mouse, a keyboard, or a touch pad.

In some implementations, the user terminal 200 may further include the output unit 250. The output unit 250 may display (output) information processed by the user terminal 200 or may transmit (send) the information to the outside. For example, the output unit 250 may visually display information processed by the user terminal 200. The output unit 250 may display UI (User Interface) information or GUI (Graphic User Interface) information, among others. In such a case, the output unit 250 may include at least one of an LCD, a TFT-LCD, an OLED, a Flexible Display, a 3D Display, or an E-ink Display. Also, for example, the output unit 250 may audibly present information processed by the user terminal 200. The output unit 250 may present audio data, following an arbitrary audio file format (for example, MP3, FLAC, WAV, etc.), through an audio device. In such a case, the output unit 250 may include at least one of a speaker, a headset, or a headphone. Also, for example, the output unit 250 may transmit information processed by the user terminal 200 to an external output device. The output unit 250 may transmit or send information processed by the user terminal 200 to the external output device by using the communication interface 220. The output unit 250 may also transmit or send information processed by the user terminal 200 to an external output device by using a separate output communication interface.

In the following description, for convenience, an operating subject may be omitted, but each operation may be understood as being performed by the server 100. However, the method according to the present disclosure may be performed by the user terminal 200, or some of the operations included in the method may be performed at the user terminal 200, and the remaining operations may be performed at the server 100.

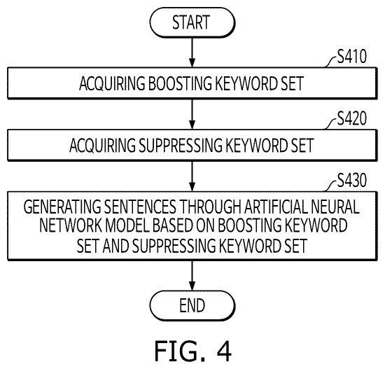

FIG. 4 is a flowchart illustrating, as an example, a natural language processing method.

The server 100 may acquire a boosting keyword set (S410). The boosting keyword set may include at least one boosting keyword that becomes an object of generation boost when generating sentences using an artificial neural network model.

In natural language processing, text data (which are target data for processing) are used after being converted into a form of data that a computer may recognize and operate. Such a conversion process may include a tokenization operation that divides text data into certain units, and an embedding operation that converts individual tokens into vector values that a computer may recognize and process. A byte pair encoding (BPE) scheme may be used for the tokenization operation. In general, BPE is a technique of creating a word vocabulary by dividing words into characters or Unicode units and then merging characters or Unicode units that appear consecutively in order according to frequency in the word vocabulary. In some implementations, the tokenization operation may be byte-level BPE. Byte-level BPE assumes that individual characters included in natural language data are expressed in UTF-8 encoding, and it refers to a technique of first creating an initial word vocabulary by dividing each character into one to N (where N is an integer of at least 1) bytes at the byte level, then performing consecutive merge steps to finally create a word vocabulary having a predetermined number of elements. Meanwhile, the embedding operation is an operation of converting each token generated through the tokenization operation into an embedding vector, and may be generated by various techniques such as Glove, FastText, or Word2Vec.

In the present disclosure, a token sequence refers to one or more continuous tokens having an order. A token sequence may include a start token indicating the start of a sentence, or an end token indicating the end of a sentence, among others. For example, for the sentence “ [symbol] -Annyounghaseyo,” a token sequence generated may be [‘ [symbol] -Annyoung’, ‘ [symbol] -ha’, ‘ [symbol] -seyo<EOS>’].

In the present disclosure, the term “keyword” is used to refer to a token sequence having a predetermined length, and includes a boosting keyword and a suppressing keyword. The term “boosting keyword” may be used to refer to a particular token sequence that is promoted to be included in a sentence when the server 100 generates the sentence using an artificial neural network model. Also, the term “suppressing keyword” may be used to refer to a particular token sequence that is suppressed from being included in the sentence when the server 100 generates the sentence using the artificial neural network model.

Next, the server 100 may acquire a suppressing keyword set (S420). The suppressing keyword set may include at least one suppressing keyword that becomes an object of generation suppression when generating sentences by using an artificial neural network model.

In some implementations of the present disclosure, the boosting keyword set is a keyword set related to a first language (for example, Korean), and the suppressing keyword set is a keyword set related to a second language (for example, English, Chinese, or Japanese). Specifically, the boosting keyword set may be configured to include token sequences that satisfy a certain occurrence condition in the entire set of token sequences after performing a tokenization operation on public text data related to the first language. Also, the suppressing keyword set may be configured to include token sequences that satisfy a certain occurrence condition in the entire set of token sequences after performing a tokenization operation on public text data related to the second language. The certain occurrence condition may be, for example, a condition that is satisfied if a token sequence appears at least a predetermined number of times (n times), or if a token sequence appears at least a predetermined probability (n %). If a sentence is generated through the artificial neural network model by using the boosting keyword set for a certain language (the first language) and the suppressing keyword set for another language (the second language different from the first language), the generation of keywords related to the first language is promoted while the generation of keywords related to the second language is suppressed, so a sentence that is more appropriate for usage in the first language may be generated. A more detailed method of generating sentences is described below.

In some implementations of the present disclosure, the boosting keyword set or the suppressing keyword set may be generated based on a word distribution in public data related to the target language and a word distribution in proprietary data input by a user. The term “public data” indicates known data that anyone may obtain via the internet, and the term “proprietary data (or unique data, user-provided data)” indicates data input by the user.

In some implementations, the boosting keyword set may include words that appear at least a predetermined number of times in the proprietary data. In other implementations, the boosting keyword set may include words that appear at or above a predetermined frequency of appearance in the proprietary data. In other implementations, the boosting keyword set may include words that appear at a frequency lower than a first threshold frequency in the public data, among which there are words that appear at a frequency higher than a second threshold frequency in the proprietary data. Specifically, the boosting keyword set may include words (that is, token sequences) that appear with low frequency (for example, 0.01% or below) in the public data, but that appear with high frequency (for example, 0.05% or above) in the user-input proprietary data. The first threshold frequency or the second threshold frequency may be suitably set based on statistics for word distributions in the public data or the proprietary data. For example, the first threshold frequency may be set to the first quartile of each word appearance probability in the public data, and the second threshold frequency may be set to the third quartile of each word appearance probability in the proprietary data. Also, the boosting keyword set may include words among those that appear at a frequency lower than the first threshold frequency in the public data, which appear at least a certain number of times in the proprietary data.

In some implementations, the suppressing keyword set may include words that appear at a frequency higher than a third threshold frequency in the public data, among which there are words that appear at a frequency lower than a fourth threshold frequency in the proprietary data. Specifically, the suppressing keyword set may include words that appear with high frequency (for example, 0.05% or below) in the public data but appear with low frequency (for example, 0.01% or below) in the user-input proprietary data. The third threshold frequency or the fourth threshold frequency, similarly to the first threshold frequency or the second threshold frequency described above, may each be suitably set based on statistics for word distributions in the public data or the proprietary data. Also, the suppressing keyword set may include words among those that appear at a frequency higher than the third threshold frequency in the public data, which appear at or below a certain number of times in the proprietary data.

As described above, the present disclosure may generate a boosting keyword set or a suppressing keyword set by comparing the word distribution in public data related to a target language and the word distribution in proprietary data input by a user. This has the effect of efficiently reflecting in sentence generation through the artificial neural network model those words that are used more frequently or less frequently in the user's proprietary data, based on the basic word distribution that the public data in the target language has.

Next, based on the boosting keyword set and the suppressing keyword set, the server 100 may generate a sentence through the artificial neural network model (S430). In the present disclosure, the sentence may be composed of one or more continuous tokens, and may include a keyword. In the present disclosure, a sentence may be a token sequence in which subsequent tokens determined repetitively at each step by the artificial neural network model are consecutively arranged.

Specifically, the server 100 may calculate a generation probability for each of a plurality of tokens based on an output of the artificial neural network model for an input token sequence. For example, the generation probability may be expressed as in Equation (1) below.

$$P ( {x}_{t} \vert {x}_{1}^{t - 1} , C ) = \frac{exp ( {W}_{{x}_{t}} \cdot {h}_{t} / T )}{{\sum }_{α ∈ V} exp ( {W}_{α} \cdot {h}_{t} / T )} \qquad [ Equation ( 1 ) ]$$

Equation (1) indicates the generation probability of a t-th token generated based on the input token sequence. Here, xₜ indicates the t-th token, and

$${x}_{1}^{t - 1}$$

indicates the input token sequence at step t, which includes the token array from the first token to the (t−1)-th token (where t is at least 1, and

$${x}_{1}^{0}$$

is ϕ). W_{α} is an embedding vector for a specific token (α) that is an element belonging to the entire set of tokens (the vocabulary, V), and hₜ denotes an output value of the model's last layer (for example, a logit function). Also, T on the right side is a probability distribution control parameter for adjusting the probability distribution, which may be referred to as a temperature. The probability distribution control parameter (T) of the present disclosure is a parameter applied comprehensively to the entire set of tokens, and as the value becomes infinitely large, an effect arises in which the entire probability values converge to similar values regardless of the model output for each token. Therefore, compared to when the probability distribution control parameter is not used, tokens with higher generation probabilities in the original probability distribution are selected less, and tokens with lower generation probabilities are selected more. Conversely, as the probability distribution control parameter value approaches zero, the model output for each token is amplified, so compared to when the probability distribution control parameter is not used, tokens with higher generation probabilities in the original probability distribution are selected more, and tokens with lower generation probabilities are selected less. As in the example of Equation (1) described above, the server 100 of the present disclosure may calculate generation probabilities for each of a plurality of tokens that correspond to elements of the entire set of tokens (V). The server 100 may determine a token with the highest calculated generation probability among those tokens as a subsequent token.

According to some implementations of the present disclosure, the server 100 may calculate generation probabilities differently according to the classification of each token. A method of calculating generation probabilities differently according to the classification of each token may be expressed, for example, as in Equations (2) through (3) below.

$$P ( {x}_{t} \vert {x}_{1}^{t - 1} , C ) = \frac{exp ( {W}_{{x}_{t}} \cdot {h}_{t} / T \cdot {T}_{{x}_{t}} )}{{\sum }_{α ∈ V} exp ( {W}_{α} \cdot {h}_{t} / T \cdot {T}_{α} )} \qquad [ Equation ( 2 ) ]$$

$${T}_{x} = \{ {T}_{B} \cdot 1 ( x ∈ {V}_{B} ) + 1 ( x ∉ {V}_{B} ) \} \times \{ {T}_{S} \cdot 1 ( x ∈ {V}_{S} ) + 1 ( x ∉ {V}_{S} ) \} \qquad [ Equation ( 3 ) ]$$

Equation (2) is an equation obtained by changing T in Equation (1) to T·Tₓ, where Tₓ denotes the token-level temperature (that is, a probability distribution control parameter) for the x-th token. Equation (3) is an equation for the token-level temperature, where T_{B} is a boosting probability distribution parameter used if the token (x) is included in a set of tokens (V_{B}) of the boosting keyword set, and Tₛ is a suppressing probability distribution parameter used if the token (x) is included in a set of tokens (Vₛ) of the suppressing keyword set. Here, the set of tokens of the boosting keyword set may be a set composed of tokens included in token sequences that make up each boosting keyword. Also, the set of tokens of the suppressing keyword set may be a set composed of tokens included in token sequences that make up each suppressing keyword. In other words, when calculating generation probabilities for each of the plurality of tokens, the server 100 may use a boosting probability distribution parameter (T_{B}) to calculate the generation probability if a token is included in the set of tokens of the boosting keyword set, thereby increasing the generation probability, and may use a suppressing probability distribution parameter (Tₛ) to calculate the generation probability if a token is included in the set of tokens of the suppressing keyword set, thereby decreasing the generation probability. Specifically, the value of the boosting probability distribution parameter (T_{B}) may be a real number less than 1 so as to increase the selection probability for tokens included in the boosting keywords, and the value of the suppressing probability distribution parameter (Tₛ) may be a real number greater than 1 so as to decrease the selection probability for tokens included in the suppressing keywords. As described above, by using different probability distribution control parameters for different classifications of tokens, the server 100 may calculate different generation probabilities for each token and then determine a subsequent token that follows the input sequence.

The server 100 of the present disclosure may generate sentences through the artificial neural network model by using a keyword trie that includes at least one node.

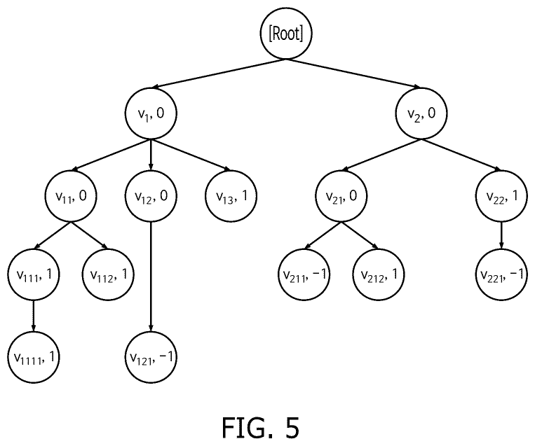

FIG. 5 is a conceptual diagram illustrating a keyword trie. Each node of the keyword trie may include a token and a keyword state value. The keyword state value of a node may be a value indicating the keyword state of the token sequence formed by sequentially arranging the tokens of each node on a path from the top node, which is the root node (Nᵣₒₒₜ), to the current node. For example, if the sequence of continuous tokens arranged along the trie structure from the root node (Nᵣₒₒₜ) to a node t (Nₜ) corresponds to a boosting keyword, the keyword state value of the node t (Nₜ) included in the keyword trie may be 1. Also, for example, if the sequence of tokens from the root node (Nᵣₒₒₜ) to the node t (Nₜ) corresponds to a suppressing keyword, the keyword state value of the node t (Nₜ) may be −1. Also, for example, if the sequence of tokens from the root node (Nᵣₒₒₜ) to the node t (Nₜ) does not correspond to a boosting keyword or a suppressing keyword, the keyword state value of the node t (Nₜ) may be 0. In the present disclosure, each node of the keyword trie may be expressed as (v, s), where v is the token held by that node and s is the keyword state value of the node. Each node of the keyword trie may have a different state value depending on whether the sequence of tokens in the path of nodes from the root node to that node corresponds to a boosting keyword, a suppressing keyword, or neither.

In the present disclosure, the keyword trie may be generated based on the boosting keyword set or the suppressing keyword set. For explanation, referring to the keyword trie of FIG. 5, assume that the boosting keyword set is a token sequence set such as {[ν₂, ν₂₂], [ν₂, ν₂₁, ν₂₁₂]} and that the suppressing keyword set is a token sequence set such as {[ν₂, ν₂₁, ν₂₁₁], [ν₂, ν₂₂, ν₂₂₁]}. In this case, since the first token of each token sequence included in the entire token sequence set is commonly ν₂, the common token ν₂ may be placed in the first parent node. Also, the token sequence ([ν₂]) according to the path from the root node to the token ν₂ is not included in either the boosting keyword set or the suppressing keyword set, so the keyword state value of the node with the token ν₂ may be 0. Therefore, the parent node of the entire set of token sequences with the token ν₂ may be expressed as (ν₂, 0). Next, in the entire token sequence set, the tokens following the token ν₂ may be token ν₂₁ or token ν₂₂, so each node including token ν₂₁ or token ν₂₂ may be arranged as a child node of the parent node ((ν₂, 0)). At this time, the token sequence ([ν₂, ν₂₁]) according to the path from the root node to token ν₂₁ is not included in the boosting keyword set or the suppressing keyword set, so the keyword state value of the node having the token ν₂₁ may be 0. Therefore, the node having the token ν₂₁ may be expressed as (ν₂₁, 0). Meanwhile, since the token sequence ([ν₂, ν₂₂]) according to the path from the root node to token ν₂₂ is included in the boosting keyword set, the keyword state value of the node with the token ν₂₂ may be 1. Therefore, the node having the token ν₂₂ may be expressed as (ν₂₂, 1). The above is only one example of generating a keyword trie based on the boosting keyword set or the suppressing keyword set, and does not limit the present disclosure.

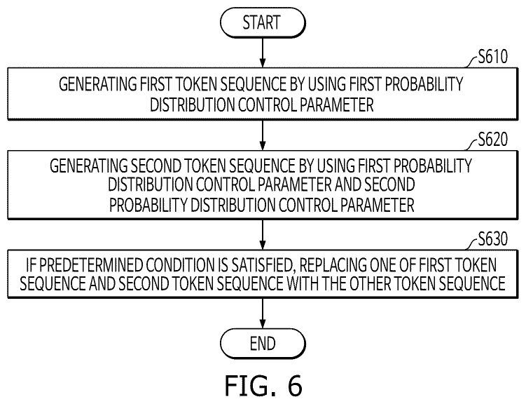

FIG. 6 is a flowchart illustrating, as an example, a first example of generating a sentence by using a keyword trie.

The server 100 may generate a first token sequence by using a first probability distribution control parameter (that is, a boosting probability distribution parameter) (S610). Specifically, at step t (t is a natural number of at least 1), the server 100 may input a first token sequence of length t−1 (including a first token through a (t−1)-th token) into the artificial neural network model, calculate generation probabilities for each of a plurality of tokens by using the first probability distribution control parameter with respect to an output of the artificial neural network model, determine a subsequent token according to the calculated generation probabilities, and attach the determined subsequent token after the (t−1)-th token, thereby generating the first token sequence of length t. The generation probabilities that the server 100 calculates for each of a plurality of tokens by using the boosting probability distribution parameter, for example, may be computed according to Equation (2) described above and Equation (4) below.

$${T}_{x} = {T}_{B} \cdot 1 ( x ∈ {V}_{B} ) + 1 ( x ∉ {V}_{B} ) \qquad [ Equation ( 4 ) ]$$

Equation (4) is an equation obtained by removing the suppressing probability distribution parameter from Equation (3), and indicates a token-level Tₓ calculation formula using the boosting probability distribution parameter (T_{B}). If the token-level Tₓ of Equation (4) is applied to Equation (2), the server 100 may calculate the generation probabilities by using the boosting probability distribution parameter.

The server 100 may generate a second token sequence by using the first probability distribution control parameter (that is, the boosting probability distribution parameter) and a second probability distribution control parameter (that is, the suppressing probability distribution parameter) (S620). That is, at step t (t is a natural number of at least 1), the server 100 may input a token sequence of length t−1 (including the first token through the (t−1)-th token) into the artificial neural network model, calculate generation probabilities for each of a plurality of tokens by using the first probability distribution control parameter and the second probability distribution control parameter for the output of the artificial neural network model, determine a subsequent token according to the calculated generation probabilities, and attach the subsequent token after the (t−1)-th token, thereby generating the second token sequence of length t. The generation probabilities that the server 100 calculates for each of a plurality of tokens by using the boosting probability distribution parameter and the suppressing probability distribution parameter, for example, may be computed according to Equations (2) and (3) described above.

If a predetermined condition is satisfied, the server 100 may replace one of the first token sequence and the second token sequence with the other token sequence (S630). The predetermined condition may be a condition whose satisfaction is determined based on the keyword trie.

If it is determined by the keyword trie that the first token sequence includes a suppressing keyword, the server 100 may replace the first token sequence with the second token sequence.

In some implementations, if the node corresponding to a newly added token in the step t for the first token sequence of length t−1 is a leaf node in the keyword trie, and the keyword state value of that node indicates a suppressing keyword (for example, −1), the server 100 may determine that the first token sequence of length t includes a suppressing keyword.

In some implementations, if the node corresponding to a newly added token in the step t for the first token sequence of length t−1 is not a leaf node in the keyword trie, and the keyword state value of that node indicates a suppressing keyword (for example, −1), the server 100 may set a variable indicating that there is a possibility that the first token sequence of length t includes a suppressing keyword to a true value, and proceed to the next step. In other words, at step t, the server 100 may defer the judgment of whether the first token sequence includes a suppressing keyword, while only storing the possibility that the first token sequence includes a suppressing keyword, and then proceed with a subsequent step (that is, step t+1 or later steps). At this time, in a subsequent step, if the variable indicating that there is a possibility the first token sequence includes a suppressing keyword is true, and the node corresponding to a newly added token to the first token sequence does not exist in the keyword trie or is a leaf node in the keyword trie having a state value indicating a suppressing keyword, the server 100 may determine that the first token sequence includes a suppressing keyword.

If it is determined by the keyword trie that the first token sequence includes a boosting keyword or does not include a suppressing keyword, the server 100 may replace the second token sequence with the first token sequence.

In some implementations, if the node corresponding to a newly added token in the step t for the first token sequence of length t−1 is a leaf node in the keyword trie, and the keyword state value of that node indicates a boosting keyword (for example, 1), the server 100 may determine that the first token sequence of length t includes a boosting keyword.

In some implementations, if, at the step t, the node corresponding to a newly added token in the first token sequence of length t−1 does not exist in the keyword trie, and if the variable indicating that there is a possibility that the first token sequence includes a suppressing keyword has a false value, the server 100 may regard the first token sequence as including a boosting keyword.

By replacing one of the first token sequence and the second token sequence with the other token sequence among the first token sequence and the second token sequence under a predetermined condition determined based on the keyword trie, the server 100 may generate a token sequence that includes more boosting keywords and fewer suppressing keywords. That is, the server 100 of the present disclosure calculates, at each step, both the first token sequence that is generated by using the boosting probability distribution parameter and the second token sequence that is generated by using both the boosting probability distribution parameter and the suppressing probability distribution parameter. If a suppressing keyword is detected in the first token sequence, the server 100 may replace the first token sequence with the second token sequence which is generated to further suppress that suppressing keyword, thereby removing the suppressing keyword. If a boosting keyword is detected in the first token sequence, the server 100 may replace the second token sequence so far with the first token sequence and thus synchronizes subsequent operations. Also, because the server 100 that uses the keyword trie to determine conditions related to suppressing keywords or boosting keywords may identify whether the token sequence includes a boosting keyword or a suppressing keyword directly based on the position of the last token's node and the keyword state value in the trie data structure, rather than performing an iteration from the entire token sequence or from the root node to the current node at every step, there is an advantage of faster operation speed.

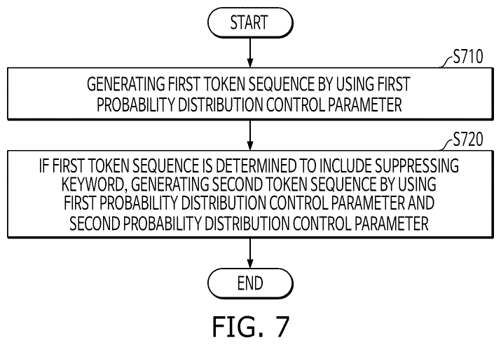

FIG. 7 is a flowchart illustrating, as an example, a second example of generating a sentence by using a keyword trie.

The server 100 may generate a first token sequence by using a first probability distribution control parameter (that is, a boosting probability distribution parameter) (S710). Since step S710 in FIG. 7 may be performed in the same or similar manner as step S610 in FIG. 6, repeated descriptions are omitted.

If the first token sequence is determined to include a suppressing keyword, the server 100 may generate a second token sequence by using the first probability distribution control parameter and the second probability distribution control parameter (S720).

If the first token sequence is determined to include a suppressing keyword, the input token sequence for generating the second token sequence may be determined based on a node path in the keyword trie at the time it is determined that the first token sequence includes the suppressing keyword.

For example, assume that the token sequence corresponding to the suppressing keyword is [νₛ₁, νₛ₂, νₛ₃], and that the node path corresponding to this token sequence in the keyword trie may be represented as [Root, (νₛ₁, 0), (νₛ₂, 0), (νₛ₃, −1)]. Also, assume that at a certain step, the server 100 created a first token sequence of length 5, [ν₁, ν₂, ν₃, νₛ₁, νₛ₂], and added a subsequent token (νₛ₃) so as to create a first token sequence of length 6, [ν₁, ν₂, ν₃, νₛ₁, νₛ₂, νₛ₃]. At that time, the server 100 may determine by means of the keyword trie that the first token sequence includes a suppressing keyword. In such a case, the server 100 may remove the token sequence ([νₛ₁, νₛ₂, νₛ₃]) corresponding to the node path of the keyword trie from the first token sequence and use that token sequence as an input token sequence ([ν₁, ν₂, ν₃]) to generate the second token sequence. In other words, for generating the second token sequence, the input token sequence to the artificial neural network model may be the token sequence obtained by removing the suppressing keyword from the first token sequence.

Unlike the first example described above, the server 100 according to the second example may generate a second token sequence to replace the first token sequence when the first token sequence is determined to include a suppressing keyword. Through this, the present disclosure may generate sentences that include many boosting keywords and fewer suppressing keywords while reducing the amount of storage space usage. Also, in the second example, because the server 100 regenerates tokens to create the second token sequence after removing the suppressing keyword included in the first token sequence, there is an effect of removing the suppressing keyword detected at or above a predetermined number of times.

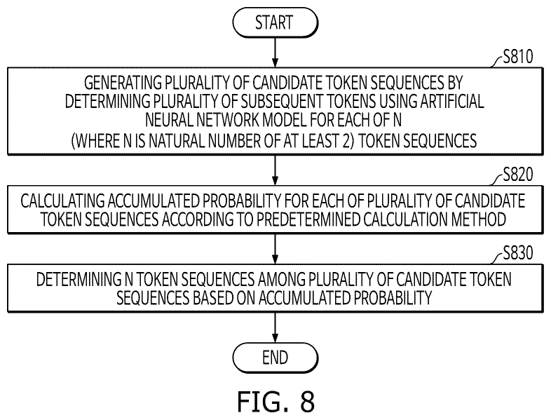

FIG. 8 is a flowchart illustrating, as an example, a third example of generating a sentence by using a keyword trie.

The server 100 may generate a plurality of candidate token sequences by determining a plurality of subsequent tokens using the artificial neural network model for each of N (where N is a natural number of at least 2) token sequences of length t (where t is a natural number of at least 1) (S810). That is, at each step, for each of the N token sequences, the server 100 may perform computation by the artificial neural network model to generate M subsequent tokens (for example), thus generating N*M candidate token sequences.

The server 100 may calculate an accumulated probability for each of the plurality of candidate token sequences according to a predetermined calculation method (S820). The accumulated probability of a token sequence may be the cumulative product of the generation probabilities of subsequent tokens newly added at each step. For example, if in a token sequence ([ν₁, ν₂, ν₃]) each token has a generation probability of 0.9, 0.8, and 0.1, respectively, the accumulated probability of that token sequence may be 0.072 (=0.9*0.8*0.1).

If a candidate token sequence is determined to include a boosting keyword, the server 100 may increase the accumulated probability. For example, if, in the candidate token sequence ([ν₁, ν₂, ν₃]), the sub-token sequence [ν₂, ν₃] corresponds to a boosting keyword, the server 100 may increase the accumulated probability of the candidate token sequence. The increase of the accumulated probability may be performed by adding a predetermined positive weight to the accumulated probability or multiplying the accumulated probability by a real number greater than 1, among other methods.

If a candidate token sequence is determined to include a suppressing keyword, the server 100 may decrease the accumulated probability. For example, if, in the candidate token sequence ([ν₁, ν₂, ν₃]), the sub-token sequence [ν₂, ν₃] corresponds to a suppressing keyword, the server 100 may decrease the accumulated probability of the candidate token sequence. The decrease of the accumulated probability may be performed by adding a predetermined negative weight to the accumulated probability or multiplying the accumulated probability by a real number less than 1, among other methods.

Based on the accumulated probability for each of the plurality of candidate token sequences, the server 100 may determine N token sequences of length t+1 among the plurality of candidate token sequences (S830). That is, if the server 100 generates M subsequent tokens in descending order of generation probability for each token sequence at each step, the server 100 may determine N token sequences in descending order of accumulated probability among the total N*M candidate token sequences at each step.

Because the server 100 according to the third example generates a sentence by considering N token sequences at each step, the server 100 may solve the problem of the greedy algorithm, which generates sentences with a single output. Further, the server 100 may generate sentences that include more boosting keywords and fewer suppressing keywords more efficiently by adjusting the accumulated probability using a keyword trie generated based on the boosting keyword set or the suppressing keyword set.

In the flowcharts or flow diagrams according to the content disclosed in the present specification, although each step of the method or algorithm is described in sequential order, the steps may be performed in any combination of orders, including being performed sequentially, or the steps may be performed in various orders. The description of the flowcharts or flow diagrams in the present specification does not exclude making changes or modifications to the method or algorithm, and does not imply that any of the steps are essential or desirable. In some implementations, at least some of the steps may be performed in parallel, in a repeated manner, or heuristically. In some implementations, at least some of the steps may be omitted, or other steps may be added.

Various embodiment(s) according to the content disclosed in the present specification may be implemented as software on a machine-readable storage medium. The software may be software for implementing various embodiment(s) of the present specification. Those skilled in the art to which the present disclosure pertains may infer this software from the various embodiment(s) of the present specification. For example, the software may be a program that includes machine-readable commands (for example, code or code segments). A machine may be a device capable of operating according to commands called from the storage medium, such as a computer. In some implementations, the machine may be a computing device according to various implementations of the present specification. In some implementations, the processor of the machine may execute the called commands, thereby causing components of the machine to perform corresponding functions of those commands. In some implementations, the processor may be the processor (110, 210) according to implementations of the present specification. The storage medium may be any kind of recording medium on which data is stored, which a machine can read. Examples of the storage medium may include ROM, RAM, CD-ROM, magnetic tapes, floppy disks, and optical data storage devices. In some implementations, the storage medium may be the memory (130, 230). In some implementations, the storage medium may be implemented in a distributed form over a networked computer system, etc. The software may be distributed across a computer system, etc., stored, and executed. The storage medium may be a non-transitory storage medium. The non-transitory storage medium indicates a tangible medium that actually exists, irrespective of whether data are stored permanently or temporarily, and does not include signals that are transmitted transitorily.

While the technical spirit according to the content disclosed in the present specification has been described through the various implementations above, the technical spirit according to the content disclosed in the present specification includes various substitutions, modifications, and changes within the scope that can be understood by those skilled in the art to which the content disclosed in the present specification pertains. Also, such substitutions, modifications, and changes should be understood to be included within the scope of the appended claims.

What is claimed is:

1. A natural language processing method performed in an electronic device comprising at least one processor and at least one memory storing commands to be executed by the at least one processor, the method comprising:
acquiring, based on a target language for sentence generation, a boosting keyword set comprising at least one boosting keyword, wherein the at least one boosting keyword is an object of generation boost when generating at least one sentence using an artificial neural network model;
acquiring, based on the target language for sentence generation, a suppressing keyword set comprising at least one suppressing keyword, wherein the at least one suppressing keyword is an object of generation suppression when generating at least one sentence using the artificial neural network model;
generating, based on the boosting keyword set and the suppressing keyword set, sentences through the artificial neural network model, wherein the generated sentences are associated with the target language; and
outputting the generated sentences.

2. The method according to claim 1, wherein the boosting keyword set is a keyword set related to a first language, and wherein the suppressing keyword set is a keyword set related to at least one second language different from the first language.

3. The method according to claim 2, wherein the first language corresponds to the target language.

4. The method according to claim 1, wherein at least one of the boosting keyword set or the suppressing keyword set is generated based on a word distribution in public data related to the target language and a word distribution in proprietary data input by a user.

5. The method according to claim 4, wherein the boosting keyword set comprises words that appear at a frequency lower than a first threshold frequency in the public data and appear at a frequency higher than a second threshold frequency in the proprietary data.

6. The method according to claim 4, wherein the suppressing keyword set comprises words that appear at a frequency higher than a first threshold frequency in the public data and appear at a frequency lower than a second threshold frequency in the proprietary data.

7. The method according to claim 1, wherein the generating the sentences through the artificial neural network model comprises:
determining a generation probability for each of a plurality of tokens based on an output of the artificial neural network model for an input token sequence;
determining, based on the generation probability, a subsequent token; and
generating, based on the subsequent token, the sentences.

8. The method according to claim 7, wherein the generation probability for each of the plurality of tokens is determined differently according to a classification of each token.

9. The method according to claim 7, wherein the generation probability for each of the plurality of tokens is determined by using:
a first probability distribution control parameter for increasing the generation probability based on a token being included in a set of tokens of the boosting keyword set; or
a second probability distribution control parameter for decreasing the generation probability based on the token being included in a set of tokens of the suppressing keyword set.

10. The method according to claim 1, wherein the generating the sentences through the artificial neural network model is performed by using a keyword trie comprising at least one node, and
wherein the at least one node comprises a token and a keyword state value for a token sequence including tokens of each node on a path from a root node to a current node.

11. The method according to claim 10, wherein the keyword trie is generated based on the boosting keyword set or the suppressing keyword set.

12. The method according to claim 10, wherein the generating the sentences through the artificial neural network model comprises:
generating a first token sequence by using a first probability distribution control parameter;
generating a second token sequence by using the first probability distribution control parameter and a second probability distribution control parameter; and
replacing, based on a predetermined condition being satisfied, one of the first token sequence and the second token sequence with the other one of the first token sequence and the second token sequence,
wherein the predetermined condition is a condition of which satisfaction is determined based on the keyword trie.

13. The method according to claim 12, wherein the replacing the one of the first token sequence and the second token sequence with the other one of the first token sequence and the second token sequence comprises:
based on the first token sequence being determined to include the suppressing keyword, replacing the first token sequence with the second token sequence; or
based on the first token sequence being determined to include the boosting keyword or determined not to include the suppressing keyword, replacing the second token sequence with the first token sequence.

14. The method according to claim 10, wherein the generating the sentences through the artificial neural network model comprises:
generating a first token sequence by using a first probability distribution control parameter; and
based on the first token sequence being determined to include the suppressing keyword, generating a second token sequence by using the first probability distribution control parameter and a second probability distribution control parameter.

15. The method according to claim 10, wherein the generating the sentences through the artificial neural network model comprises:
generating a plurality of candidate token sequences by determining a plurality of subsequent tokens using the artificial neural network model for each of N token sequences where N is a natural number greater than or equal to 2;
calculating, according to a predetermined calculation method, an accumulated probability for each of the plurality of candidate token sequences; and
determining, based on the accumulated probability, the N token sequences among the plurality of candidate token sequences.

16. The method according to claim 15, wherein the calculating the accumulated probability for each of the plurality of candidate token sequences comprises:
based on a candidate token sequence being determined to include the boosting keyword, increasing the accumulated probability; or
based on the candidate token sequence being determined to include the suppressing keyword, decreasing the accumulated probability.

17. An electronic device comprising:
at least one processor; and
at least one memory storing commands, when executed by the at least one processor, that are configured to cause the electronic device to:
acquire, based on a target language for sentence generation, a boosting keyword set comprising at least one boosting keyword, wherein the at least one boosting keyword is an object of generation boost when generating at least one sentence using an artificial neural network model;
acquire, based on the target language for sentence generation, a suppressing keyword set comprising at least one suppressing keyword, wherein the at least one suppressing keyword is an object of generation suppression when generating at least one sentence using the artificial neural network model;
generate, based on the boosting keyword set and the suppressing keyword set, sentences through the artificial neural network model, wherein the generated sentences are associated with the target language; and
output the generated sentences.

18. A non-transitory computer-readable recording medium storing commands, when executed by at least one processor, that are configured to cause an electronic device to:
acquire, based on a target language for sentence generation, a boosting keyword set comprising at least one boosting keyword, wherein the at least one boosting keyword is an object of generation boost when generating at least one sentence using an artificial neural network model;
acquire, based on the target language for sentence generation, a suppressing keyword set comprising at least one suppressing keyword, wherein the at least one suppressing keyword is an object of generation suppression when generating at least one sentence using the artificial neural network model;
generate, based on the boosting keyword set and the suppressing keyword set, sentences through the artificial neural network model, wherein the generated sentences are associated with the target language; and
output the generated sentences.
